(19) United States
(12) Patent Application Publication
(10) Pub. No.: US 2018/0331517 A1
(43) Pub. Date: Nov. 15, 2018

(54) A PIPE CONNECTOR FITTING

(71) Applicant: CRALEY GROUP LIMITED, Hampshire (GB)

(72) Inventor: Michael PARKER, Hampshire (GB)

(21) Appl. No.: 15/776,581

(22) PCT Filed: Nov. 11, 2016
(86) PCT No.: PCT/GB2016/053542

§ 371 Date: May 16, 2018

(30) Foreign Application Priority Data
Nov. 16, 2015 (GB) 1520188.2

(51) Int. Cl. H02G 1/08; F16L 41/02

(52) U.S. Cl. CPC H02G 1/086; F16L 41/023

(57) ABSTRACT

A pipe connector fitting 2 comprises first and second connectable sections 4, 6 which when positioned together form a substantially cylindrical configuration comprising a hollow interior 8 for enclosing a portion of a fluid pipe, in use. The first section 4 additionally comprises a protruding tube 10 which has a bore 12 providing access to the hollow interior 8 of the fitting. In use, the first section 4 and second section 6 are placed coaxially about a fluid pipe and are brought into a abutting relationship. Nut and bolt connections 18, 20 are used to secure the first and second sections 4, 6 about the fluid pipe via flanges 14, 14′, 16, 16′. The bore 12 allows for the insertion of one or more elongate flexible members, such as a cable into a fluid pipe via a corresponding opening provided in the pipe.

### TECHNICAL FIELD OF THE INVENTION

The present invention relates to improvements in or relating to pipe connector fittings and in particular to fittings adapted to enable one or more elongate flexible members, such as a cable, to be introduced into a fluid pipe.

### BACKGROUND TO THE INVENTION

It is known in the art to utilise pre-existing fluid pipes, such as those commonly used for water, waste water, sewage or gas, for example, as conduits through which new cables are introduced. In this way it is possible to provide new cable systems, or upgrade existing cable systems, without the need for the installation of overhead cables or further excavation to lay the new cables in dedicated conduits. Systems of this type therefore tend to be much less expensive and are less disruptive in cases where a cable system may pass across a public highway, or private land, which would otherwise have to be excavated to lay additional conduits.

Examples of such systems include that disclosed in GB2463372B which covers a system whereby a section of pipe is removed and replaced by a connector fitting which provides both the conduit through which fluid flows along in the same way as the section of pipe which was removed, and also an aperture into which one or more cables can be introduced into the pipe. However, whilst the system disclosed in this document provides an effective means of allowing the introduction of cables into the fluid pipe, the additional stages of cutting the pre-existing section of the pipe to allow for the installation of the connector fitting can be time consuming and expensive.

Furthermore, in some instances it may be desirable to use pre-existing fluid pipes within an apartment block, hotel or the like which comprises a plurality of different rooms in order to supply one or more cable connections to each room. In such cases, it is common for a mains fluid supply line to be split at a services cabinet into a plurality of secondary supply lines to provide water or other fluids to any number of rooms. A mains cable line may similarly be split at such a cabinet. As such, in order to lay one or more cables along each secondary supply lines it is necessary to provide one or more connector fittings within the services cabinet itself. However, prior art connector fittings are not suited to such an installation. Service cabinets of this type can generally comprise a confined space and therefore it is necessary to provide a connector fitting which takes up as small amount of space as possible. Furthermore, such a confined space is not suited to the complex installation processes associated with prior art connector fittings, such as cutting away a section of the pipe or the like.

It would therefore be advantageous to provide a pipe connector fitting adapted to enable the introduction of one or more elongate flexible members, such as cables, into a fluid pipe which may be affixed to a pipe without the need to remove a portion of the pipe. It would also be advantageous to provide a pipe connector fitting adapted to enable the introduction of one or more elongate flexible members, such as cables, into a fluid pipe which may be affixed to a pipe within a services cabinet or the like within a building which comprises a plurality of rooms.

It is an object of the present invention to provide a pipe connector fitting that at least partly overcomes or alleviates the above problems.

### SUMMARY OF THE INVENTION

According to a first aspect of the present invention there is provided a pipe connector fitting for introducing one or more elongate flexible members into a fluid pipe, the connector fitting comprising: a body formed from at least two connectable sections which, when connected, provides a hollow interior adapted to fit coaxially about the fluid pipe providing a watertight fit therewith; wherein at least one section of the body comprises a protruding portion having a bore therethrough, the bore providing access to the interior of the body from the exterior of the body enabling the introduction of the one or more elongate flexible members into the fluid pipe through said bore and a corresponding opening within the pipe itself.

Providing a body in two or more connectable sections allows for the body to be positioned coaxially about the pipe and suitably secured in place without the need to cut the pipe itself. In this way, the connector fitting of the present invention provides a relatively quick and easy connection to a pre-existing pipe when compared with known fittings.

In presently preferred embodiments, the body of the pipe connector fitting comprises a complimentary shape to the outer surface of the fluid pipe to which it is to be connected. For example, for standard cylindrical pipes, the body of the connector fitting may comprise a substantially cylindrical configuration which is hollow therethrough for accommodating a section of the pipe. In such embodiments, the body comprises an inner diameter defining the hollow interior of the body and an outer diameter corresponding to the size of the body of the connector fitting itself. The inner diameter of the body may be substantially equal to, and preferably slightly greater than the outer diameter of the pipe such that the body can be positioned coaxially about the pipe in a close fit.

The body of the pipe connector fitting of the present invention is formed from two or more connectable sections. In some embodiments the body comprises more than two sections, however, in presently preferred embodiments the body is formed from two sections, only. At least one of the sections forming the body of the connector fitting may additionally comprise an outwardly extending flange. The or each outwardly extending flange may provide a means to connect the corresponding section to an adjacent section of the body, in use.

In embodiments wherein the body is substantially cylindrical it may be formed of two semi-cylindrical sections each having a semi-circular cross-section. Each semi-cylindrical section may comprise an inner curved surface, an outer curved surface, a pair of opposing straight edges and a pair of opposing curved edges. In this way, each of the semi-cylindrical sections comprises a ‘hollow’ semi-cylindrical configuration. In use, at least a section of each of the straight edges of each semi-cylindrical section may abut a corresponding straight edge of the other semi-cylindrical section such that the two sections when in said abutting relationship form the substantially cylindrical, hollow body of the connector fitting.

In some embodiments each semi-cylindrical section may comprise one or more outwardly extending flanges which may be provided at or along an edge of the section.

The or each flange may provide the means to connect the two connectable sections to one another to form the body of the connector fitting. In some embodiments each semi-cylindrical section comprises a flange running along substantially the entire length of at least one of its edges. The or each edge at or along which the one or more outwardly extending flanges are provided is preferably a straight edge of the section. In presently preferred embodiments each of the semi-cylindrical sections forming the body comprises a flange along at least a portion of both of its opposing straight edges. In this way, when the sections are positioned about a pipe, in use, each flange is paced into an abutting relationship with a corresponding flange of the other section of the body.

The two or more sections of the body may be connectable by any suitable means which may provide a permanent or a releasable connection. In some embodiments the two or more sections are connected by means of one or more nut and bolt fittings. In further embodiments, at least two of the sections may be connected by means of a hinge. In this way, the sections may be positioned about a pipe by rotating the sections about the hinge. In embodiments wherein the body is formed from two sections only, the sections may be connected firstly by a hinge and a secondly by another form of connection means, such as a nut and bolt connection, for example. In this way, the sections may be rotated about the hinge to locate the body about a pipe, and subsequently secured in position using the second connection means.

In embodiments wherein each section comprises at least one outwardly extending flange, the or each flange may provide the connection means between the two or more sections. For example, the or each flange may be provided with at least one aperture therethrough for accommodating the nut and bolt connection means. Alternatively, the or each flange of a first section of the body may be connectable to a flange of an adjacent section to form a hinged connection between the two adjacent sections.

At least one of the sections forming the body of the connector fitting comprises a protruding portion having a bore therethrough. In some embodiments the protruding portion may comprise an outwardly extending tube. In such embodiments the bore may pass through substantially the centre of the tube. In this way, the bore through the protruding tube provides access to the hollow interior of the body of the connector fitting and hence to the interior of a pipe, through a corresponding opening in the pipe, in use.

The bore through the protruding portion may be dimensioned to allow one or more elongate flexible members to be passed therethrough. In some embodiments the bore may additionally comprise one or more sealing members operable in use to provide a water tight seal between an interior surface of the protruding portion and the one or more elongate flexible members passing therethrough. The one or more sealing members may comprise O-ring seals or similar. In this way, there is provided a watertight seal around the one or more elongate flexible members preventing fluid from within the pipe being expelled through the bore within the protruding portion.

To accommodate elongate flexible members with different diameters, the connector fitting may additionally comprise an adaptor fitting operable in use to be located within the bore of the protruding portion. The adaptor fitting comprises a secondary bore therethrough, smaller than the bore of the protruding portion but is specifically dimensioned to accommodate elongate flexible members having a given diameter.

The adaptor fitting may comprise one or more additional sealing means. The additional sealing means may provide a watertight connection between the adaptor fitting and an interior surface of the protruding portion, or may provide a watertight connection between the one or more elongate flexible members and an interior surface of the adaptor fitting itself.

The adaptor fitting may comprise a cable connection system as is described in the Applicant's granted European Patent No. EP2594000 which is suited to form a watertight connection between a length of cable within a pipe and a length of cable outside the pipe through a suitable opening, such as the bore through the body of the connector fitting of the present invention.

In some embodiments the protruding portion is positioned such that the bore therethrough is directed substantially perpendicular to the direction of flow of fluid along the pipe. However, in presently preferred embodiments, the protruding portion is positioned such that the bore is directed at an angle which is not perpendicular to the direction of flow of fluid along the pipe, which is preferably less than, but may be greater than 90°. Providing the bore at an angle which is less than 90° limits the angle through which the one or more elongate flexible members must bend when transferring from the connector fitting into the interior of the pipe. It is desirable for this angle to be as small as possible.

The protruding portion may in some embodiments extend inwardly forming a spur which extends into the interior of the body of the connector fitting. At least a portion of the inwardly extending spur may be dimensioned to be received within the opening in the pipe, in use. For example, in some embodiments the inwardly extending spur may be dimensioned to be a close sliding fit within the opening within the pipe. In this way, the inwardly extending spur may provide a means to ensure that the connector fitting is correctly located onto the pipe during installation.

The body of the connector fitting is adapted to fit coaxially about the fluid pipe with a watertight connection being provided therebetween. To achieve this, the body may comprise one or more sealing means, which may be O-ring seals or the like. In some embodiments there may be provided O-ring seals about the entirety of the pipe ensuring a watertight connection between the pipe and the body of the connector fitting itself. In some embodiments at least one of the sections of the body may comprise a sealing means operable in use to provide a water tight seal about the opening provided within the fluid pipe. In such embodiments, the sealing means may be provided about an inwardly protruding spur of a section of the body providing a watertight connection between the section of the body and the pipe when the spur is located within the opening in the pipe, in use.

In some embodiments at least one of the one or more elongate flexible members may comprise a cable. Additionally or alternatively, at least one of the one or more elongate flexible members may comprise a micro-duct. In such embodiments, the micro-duct may contain at least one cable. The cable may be an optical cable. The cable is preferably provided with an insulating sheath. The cable may be a single core or multi-core cable as desired.

In some embodiments the body of the connector fitting may be adapted to enable an air compressor or other source of compressed air to be connected thereto. The connection between the connector fitting and the air compressor may be operable to enable the supply of compressed air to the interior of the connector fitting, in use. In some embodiments the source of compressed air may be connectable to the protruding portion of the connector fitting such that compressed air may be supplied to the interior of the connector fitting through the bore within the connector fitting. In this way, the connector fitting of the present invention provides a means to enable one or more elongate flexible members to be blown through the connector fitting and subsequently along a fluid pipe with the connector fitting in position. The source of compressed air may be detachable from the connector fitting such that subsequent to the blowing of one or more elongate flexible members through the pipe, it may be removed.

According to a second aspect of the present invention there is provided a kit of parts for laying one or more elongate flexible members within a fluid pipe, the kit of parts comprising at least one connector fitting in accordance with the first aspect of the invention and one or more elongate flexible members.

The kit of parts in accordance with the second aspect of the present invention may incorporate any or all of the features of the connector fitting of the first aspect of the present invention as desired or appropriate.

The kit of parts may additionally comprise an air compressor. The air compressor may be operable in use to introduce compressed air into the interior of the at least one connector fitting to enable the one or more elongate flexible members to be blown along a connected fluid pipe.

In some embodiments the air compressor may comprise part of the at least one connector fitting. In alternative embodiments the air compressor is a separate part which is connectable to the or each connector fitting in use via a suitable air adapter fitting. In some embodiments the adapter fitting may be connectable to the protruding portion of the at least one connector fitting such that compressed air may be supplied to the interior of the connector fitting through the bore within the connector fitting. In this way, the kit of parts of the present invention provides a means to enable one or more elongate flexible members to be blown through a connector fitting and subsequently along a fluid pipe with the connector fitting in position. The air adapter fitting may be detachable from the at least one connector fitting and or the air compressor such that subsequent to the blowing of one or more elongate flexible members through the pipe, the air compressor may be removed.

In embodiments wherein the elongate flexible member inserted into the pipe is a microduct, the kit may further comprise a microduct air adapter fitting operable to enable both cables and compressed air to be introduced to the interior of the microduct. In a preferred embodiment, the microduct air adapter fitting comprises a central bore along which a cable can pass and sealable opening at either end of the central bore, one opening adapted to seal around the exterior of an introduced cable and the other opening adapted to seal around the exterior of the microduct. Typically said seals may comprise one or more o-rings and/or lip seals. The central bore may be connected to a side branch operable to receive a supply of compressed air, from an air compressor (or from another source). Introducing compressed air to the microduct along with the cable reduces friction between the cable and the interior of the microduct during insertion and helps push the cable along the microduct. As a result, this makes hand pushing of the cable through the microduct considerably easier and/or increases the effective range of hand pushing operations.

The kit of parts may additionally comprise a means to form an opening within a fluid pipe. In some embodiments the means to form an opening with the fluid pipe may comprise a drill member or the like, operable in use to core drill the pipe to provide the opening. In embodiments wherein the kit of parts additionally comprises a pressure chamber, the drill member (or equivalent) may be integral with or may be connectable to the pressure chamber. In this way, the pressure chamber may be positioned on the at least one connector fitting allowing for the opening to be formed in the pipe with the at least one connector fitting in place and without the fluid flow through the pipe being interrupted.

The one or more elongate flexible members of the kit of parts may be provided with a means to enable the one or more elongate flexible members to be blown along a fluid pipe. The means may be releasably connectable to a portion of at least one of the or each elongate flexible members and may comprise any means which is operable in use to move under the influence of compressed air. Preferably, the means comprises one or more surfaces upon which the supplied compressed air may act. The means may comprise a polymer blowing ball, a micro-parachute or a blowing sponge, for example.

The one or more elongate flexible members of the kit of parts may comprise a grooved, ribbed or corrugated outer surface. In this way, the one or more elongate flexible members may have an increased flexibility when compared with members which comprise a flat outer surface. Embodiments of this type may be desirable wherein the fluid pipe into which the members are introduced is not straight but comprises a number of junctions or turns through which the members must bend.

In some embodiments the kit of parts may comprise an extraction scoop. In use, the extraction scoop may be operable to extract one or more elongate flexible members from within a fluid pipe. For example, subsequent to the one or more elongate flexible members being blown along the fluid pipe it may be desirable to extract the or each member from within the pipe. In such cases this may be done through an additional opening within the pipe, downstream of a first opening within the pipe onto which a connector fitting in accordance with the present invention may be fitted. In some embodiments the extraction scoop may comprise a flared surface which, in use, may be positioned within the interior of the pipe, through an opening within the pipe, and is operable to direct one or more elongate flexible members being blown along the pipe out through the additional opening in the pipe.

The kit of parts may in some embodiments comprise a pair of connector fittings in accordance with the first aspect of the present invention. In such embodiments the first connector fitting may be positioned at a first opening within the fluid pipe and be operable in use to introduce the one or more elongate flexible members into the pipe. As discussed above, in some uses of the kit of parts it may be necessary to provide an additional opening within the pipe operable in use to enable extraction of the one or more elongate flexible members from within the pipe. In such instances, the second connector fitting may be connected at the second opening and may act to provide a watertight seal around the additional opening in the pipe. In this way, the kit of parts of the present invention provides a means to lay one or more elongate flexible members along a desired length of a fluid pipe.

According to a third aspect of the present invention there is provided a method of laying one or more elongate flexible members within a fluid pipe using a pipe connector fitting in accordance with the first aspect of the present invention, or the kit of parts of the second aspect of the invention, the method comprising the steps of:
(a) locating the body of the connector fitting coaxially about a portion of the fluid pipe by positioning two or more sections of the body around the pipe;
(b) securing the sections of the body in position by connecting each of the two or more sections to at least one further section of the body; and
(c) introducing one or more elongate flexible members intro the fluid pipe through a bore through a protruding portion of a section of the body and a corresponding opening in the pipe.

Locating the body of the connector fitting coaxially about a portion of the fluid pipe may initially comprise locating a first section of the body in position by introducing an inner protruding spur into the opening within the fluid pipe. In doing so, this may ensure that the first section of the body is correctly positioned with respect to the fluid pipe.

In some embodiments the opening in the pipe may comprise a pre-existing opening in the pipe. However, in some embodiments the method may comprise providing the opening within the pipe prior to connecting the connector fitting thereto. In such embodiments, providing the opening within the pipe may comprise core drilling the pipe to provide the opening. In some embodiments the method may comprise providing the opening within the pipe after connecting the connector fitting thereto. In such embodiments, the opening may be provide by core drilling the pipe through the bore in the connector fitting.

The method may additionally comprise isolating the fluid supply to the section of pipe into which the one or more elongate flexible members are to be introduced. It may be advantageous to do this to prevent fluid from being expelled from within the pipe during installing of the connector fitting. The isolation of the fluid supply to the pipe may take place prior to the core drilling of the pipe in embodiments wherein the opening in the pipe needs to be formed.

The method may additionally comprise blowing the one or more elongate flexible members introduced into the fluid pipe along a length of the pipe. In such embodiments the method may comprise blowing the one or more elongate flexible members using a source of compressed air. The compressed air may be provided by an air compressor which may be connectable to the connector fitting.

In embodiments wherein the method comprises blowing the one or more elongate flexible members introduced into the fluid pipe along a length of the pipe subsequent to introduction, the method may additionally comprise extracting the one or more members from within the pipe at a desired location. In such embodiments, the one or more elongate flexible members may be removed through an additional opening within the pipe at the desired location.

Extracting the one or more elongate flexible members from within the pipe may comprise placing an extraction scoop of the kit of parts of the present invention into the pipe, through the additional opening. The extraction scoop may act to guide the one or more elongate flexible members out from within the pipe through the opening.

In embodiments wherein there is provided an additional opening within the fluid pipe, the method may comprise connecting a second connector fitting at the additional opening to provide a watertight seal at said opening which provides a passage for the one or more elongate flexible members to be taken out of the pipe. The second connector fitting may be connected to the pipe in substantially the same way as the first connector fitting, however, in some embodiments the second connector fitting may be connected to the pipe subsequent to the one or more elongate flexible members being extracted from within the pipe. In such embodiments the method comprises passing the one or more elongate flexible members through a bore within a protruding portion of a section of the body of second connector fitting during installation of the sections of the body of the second connector fitting.

In some embodiments, wherein the elongate flexible member is a microduct, the method may include the step of pushing a cable along the microduct after insertion into and extraction from the pipe. In a preferred embodiment, a source of compressed air may be used to aid the pushing of the fibre along the microduct. The compressed air may be provided by an air compressor. These method steps may be enabled by the use of a microduct air adapter fitting operable to enable both fibres and compressed air to be introduced to the interior of the microduct.

### DETAILED DESCRIPTION OF THE INVENTION

In order that the invention is more clearly understood, embodiments thereof will now be described, by way of example only, and with reference to the accompanying drawings, in which:

FIG. 1 is a side cross sectional view of a first embodiment of a pipe connector fitting in accordance with the present invention;

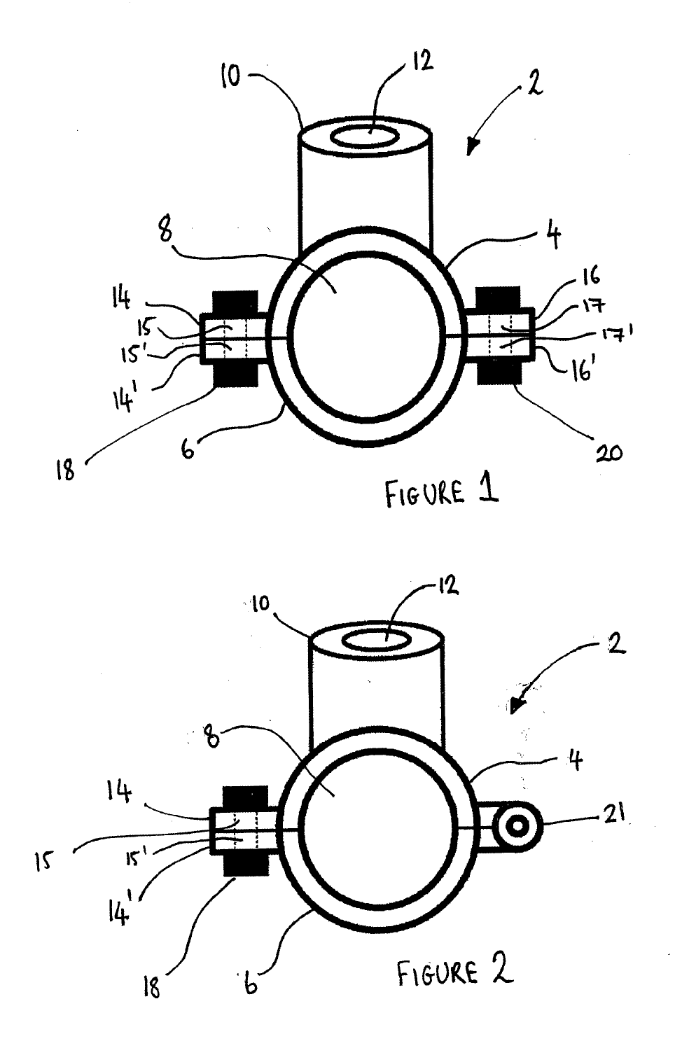

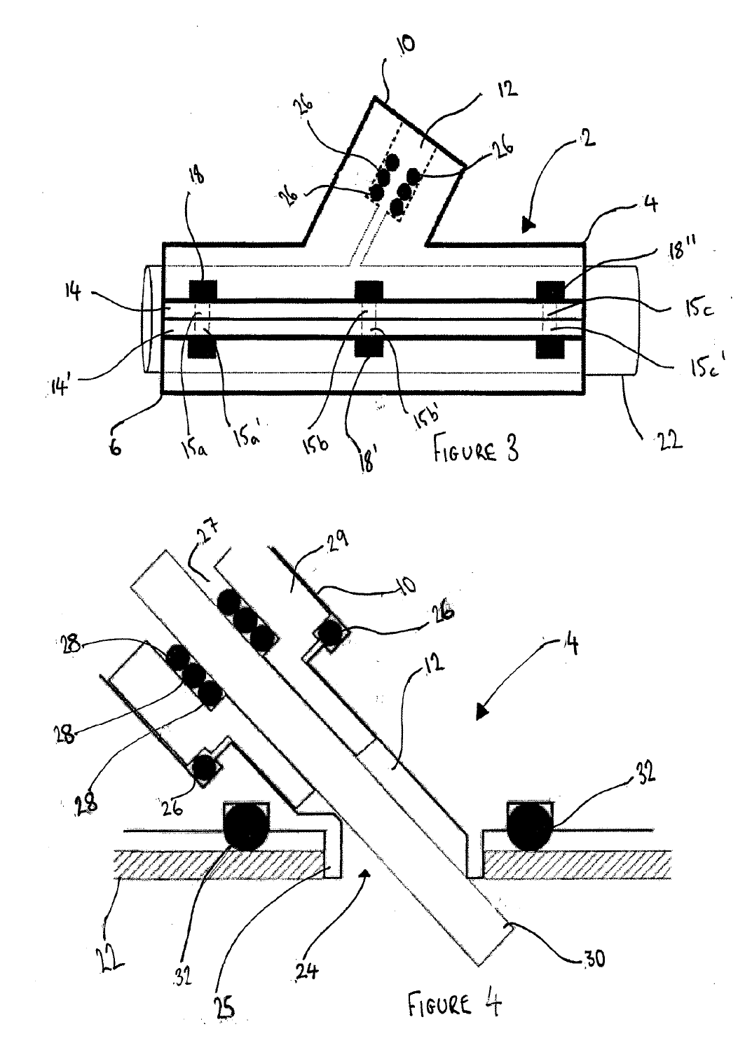

FIG. 2 is a side cross sectional view of a second embodiment of a pipe connector fitting in accordance with the present invention;

FIG. 3 is a side cross sectional view of the embodiment of the pipe connector fitting shown in FIG. 1 illustrating the fitting in position on a fluid pipe;

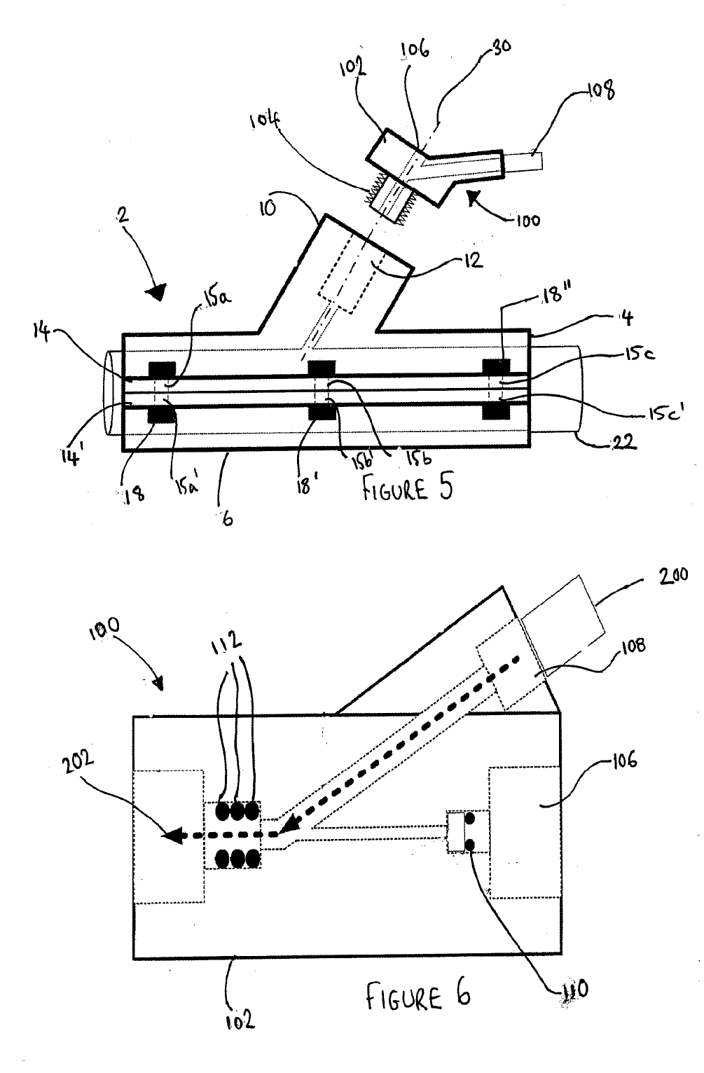

FIG. 4 is a further side cross sectional view of the pipe connector fitting shown in FIGS. 1 and 3;

FIG. 5 is a further side cross sectional view of the pipe connector fitting shown in FIGS. 1, 3 and 4, further illustrating a removable air adapter fitting for connecting a source of compressed air for use in some embodiments of the present invention;

FIG. 6 is a side cross sectional view of a microduct air adapter fitting and an air compressor adaptor for use in accordance with some embodiments of the present invention;

FIG. 7 is a schematic overview of a system in which a pair of pipe connector fittings in accordance with the present invention are implemented;

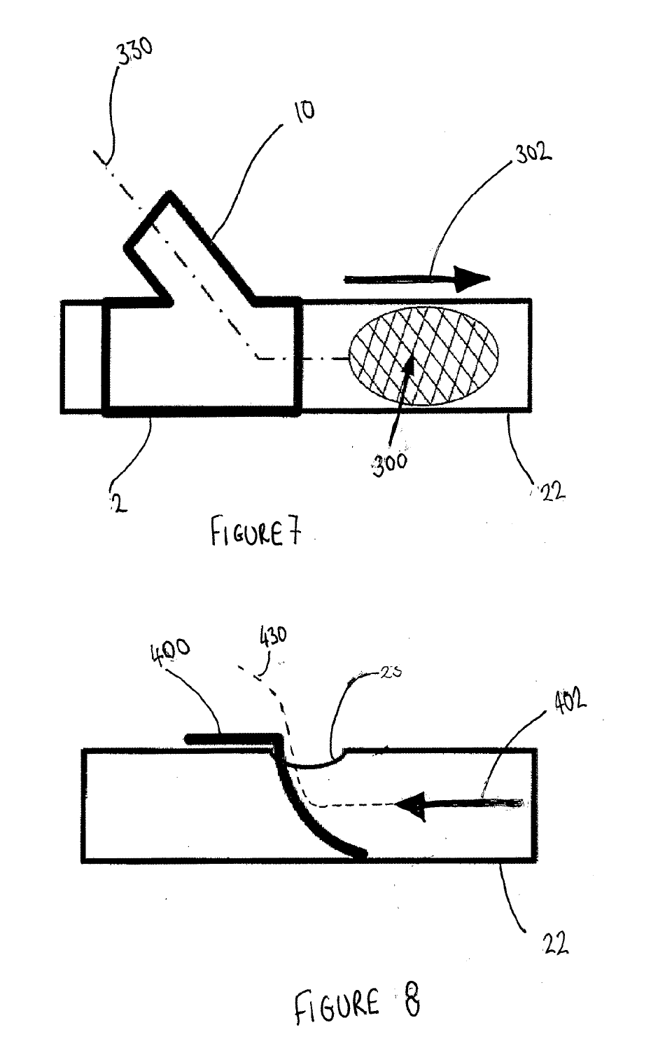

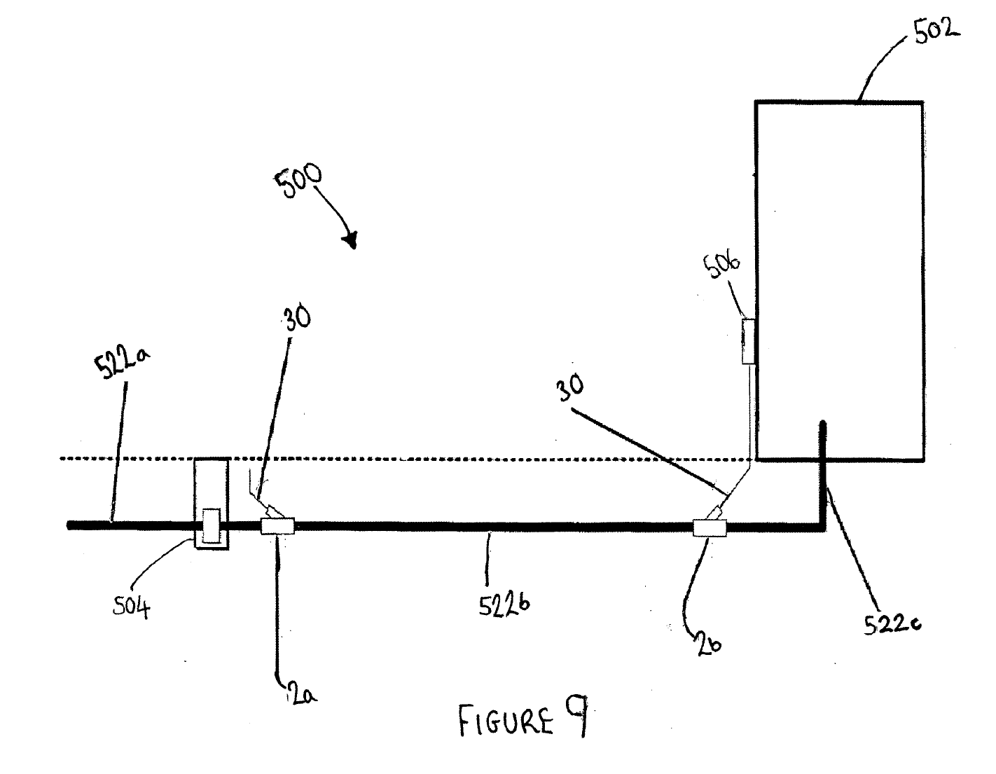

FIG. 8 is a schematic overview of a further system in which a pair of pipe connector fittings in accordance with the invention are implemented;

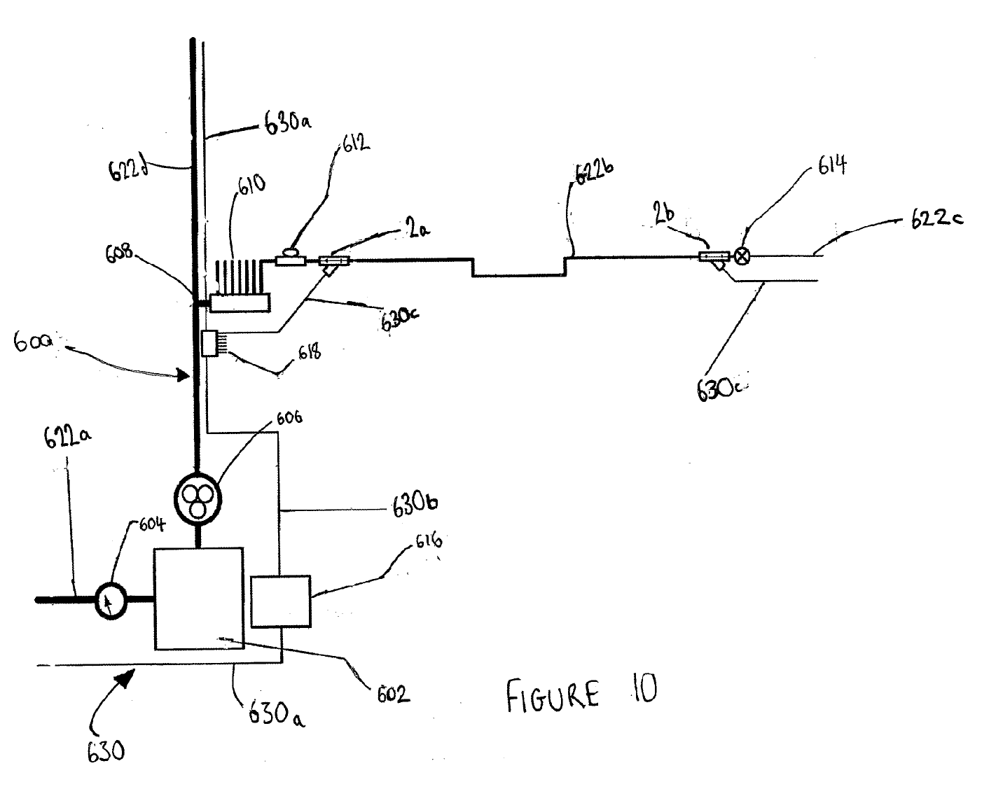

FIG. 9 is a side cross sectional view of a section of pipe illustrating the operational use of a kit of parts of the present invention; and

FIG. 10 is a side cross sectional view of a further section of pipe illustrating the operational use of an extraction scoop of a kit of parts in accordance with an aspect of the invention.

The Figures illustrate a number of embodiments of a pipe connector fitting in accordance with the present invention. Where different embodiments comprise equivalent components to other illustrated embodiments, like numerals have been used.

FIG. 1 illustrates a first embodiment of a pipe connector fitting 2 in accordance with the invention. The fitting 2 comprises first and second connectable sections in the form of a first half cylindrical section 4 and second half cylindrical section 6. The first and second sections 4, 6 when positioned together form a substantially cylindrical configuration comprising a hollow interior 8 for enclosing a portion of a fluid pipe, in use.

The first section 4 additionally comprises a protruding portion in the form of tube 10 which has a bore 12 running therethrough. The bore 12 provides access to the hollow interior 8 of the connector fitting 2 from outside of the connector fitting 2.

Each of the first and second sections 4, 6 comprise a first outwardly extending flange 14, 14′ and a second outwardly extending flange 16, 16′. The flanges 14, 14′, 16, 16′ are located along opposing straight edges of the respective section 4, 6 of the connector fitting 2. In position, the flanges 14, 16 of the first section 4 of the connector fitting are located next to corresponding flanges 14′, 16′ respectively of the second section 6 in an abutting manner.

Flanges 14, 14′, 16, 16′ each additionally comprise a respective bore 15, 15′, 17, 17′ running therethrough. In the abutting relationship as described above, bores 15, 15′ and 17, 17′ of the respective flanges 14, 14′, 16, 16′ align to provide respective bores running through the flanges 14, 14′, 16, 16′ . These bores are used to enable respective nut and bolt connections 18, 20 to secure the first and second sections 4, 6 of the connector fitting 2 in place as shown.

In use, the first section 4 and second section 6 of the connector fitting 2 are placed coaxially about a fluid pipe and are brought into the abutting relationship (as described above). The nut and bolt connections 18, 20 are used to secure the first and second sections 4, 6 about the fluid pipe.

The bore 12 through the tube 10 of the first section 4 of the connector fitting 2 allows for the insertion of one or more elongate flexible members, such as a cable or the like, to be inserted into a fluid pipe to which the connector fitting 2 is connected to. To enable this, the bore 12 is aligned with a corresponding opening provided in the fluid pipe as will be desired in further detail hereinbelow.

FIG. 2 illustrates a further embodiment of connector fitting 2 and where applicable, like reference numerals have been used for convenience. However, the fitting 2 illustrated in this Figure differs from the fitting shown in FIG. 1 in that the flanges 16, 16′ of the first and second sections 4, 6 are replaced with a single hinge connection 21. The hinge connection 21 enables the first and second sections 4, 6 of the connector fitting 2 to rotate with respect to one another and be secured in position by a nut and bolt connection 18 in a similar fashion to that described above with reference to FIG. 1.

In use, the first section 4 and second section 6 of the connector fitting 2 are rotated with respect to one another to enable them to be positioned coaxially about a fluid pipe and in doing so bringing the flange 14 of the first section 4 into contact with the flange 14′ of the second section 6. The nut and bolt connection 18 is then used to secure the first and second sections 4, 6 in position about the fluid pipe.

As with the fitting shown in FIG. 1, the bore 12 through the tube 10 of the first section 4 of the connector fitting 2 allows for the insertion of one or more elongate flexible members, such as a cable, microduct or the like, to be inserted into a fluid pipe to which the connector fitting 2 is connected to. Therefore, to enable this, the bore 12 is aligned with a corresponding opening provided in the fluid pipe when the sections 4, 6 are respectively rotated about the pipe to bring the fitting 2 into position.

FIG. 3 shows a cross sectional view of a further embodiment of the connector fitting 2 of the present invention. The connector fitting 2 is shown in position coaxially about a fluid pipe 22.

As with the embodiments shown in FIGS. 1 and 2, the connector fitting 2 comprises a first half cylindrical section 4 and a second half cylindrical section 6. The first and second sections 4, 6 are connected to one another using nut and bolt connections 18, 18′, 18″, where connections 18′, 18″ are equivalent to connection 18 and are located at set distances along the flanges 14, 14′ of the first and second sections 4, 6 through respective bores 15b, 15b′; 15c, 15c′ through flanges 14, 14′. The sections 4, 6 may be connected on the opposing side of the pipe 22 either by further nut and bolt connections 20 (as shown in FIG. 1) or by a hinged connection 21 (as shown in FIG. 2).

FIG. 3 also further illustrates the bore 12 through the tube 10 of the first section 4. The bore 12 comprises a first portion which has a first diameter and is located at an open end of the tube 10 and a second portion which has a second diameter, the second diameter being smaller than the first diameter, with the second portion being located interior to the first portion and adjacent to the pipe 22, in use. The first portion is operable in use to receive one or more elongate flexible members, which may comprise a cable or microduct, for example, and comprises a series of O-Ring seals 26 which provide a water tight connection between the one or more elongate flexible members and the interior surface of the bore 12. The second portion of the bore 12 is preferably dimensioned to be equal, or substantially equal, in diameter to the one or more elongate flexible members. In this way, the bore 12 provides a water tight opening for introducing one or more elongate flexible members into an opening (not shown) the fluid pipe 22.

FIG. 4 further illustrates how the first section 4 of the connector fitting 2 fits onto the fluid pipe 22. As shown, the fluid pipe 22 includes an opening 24 therein into which a protruding portion 25 of the first section 4 may be positioned. The protruding portion 25 allows for the first section 4 to be accurately located on the fluid pipe 22 and be loosely retained in position before securing the first section 4 in position using the connections 18, 18′, 18″ as described above.

Also shown in FIG. 4 is the provision of a further O-Ring seal 32 on the first section 4 which when positioned on the fluid pipe 22 as shown provides a water tight seal between the connector fitting 2 and the fluid pipe 2 to prevent fluid being expelled from within the fluid pipe 2.

FIG. 4 further illustrates the position of a single elongate flexible member when introduced into the fluid pipe 22 using the connector fitting 2 of the invention. Furthermore, to enable the connector fitting 2 to accommodate a range of diameters of elongate flexible member 30 shown in the Figure, the illustrated connector fitting 2 also comprises an adapter fitting 29. The adapter fitting 29 is operable to be inserted into the bore 12 in the tube 10 and contact the O-ring seals 26 to provide a water tight connection between the adapter 29 and the interior surface of the bore 12. The adapter 29 itself comprises a bore 27 therethrough into which the cable 30 is inserted. The adapter 29 further comprises a series of O-ring seals 28 which provide a water tight connection between the elongate flexible member 30 and the interior surface of the adapter 29.

FIG. 5 illustrates an air adapter fitting 100 operable to enable an air compressor to be connected to the connector fitting 2 to enable compressed air to be supplied to the interior of the fitting 2. In use, this may be used to force an elongate flexible member through the connector fitting 2 and subsequently along the fluid pipe 22 in order to lay the elongate flexible member within the fluid pipe 22 in accordance with a method of the invention. The air adaptor fitting 100 comprises a main body portion 102 and means to connect the unit 100 within the bore 12 of the connector fitting 2 in the form of connection portion 104. The main body portion 102 includes a pair of openings 106, 108 therein for introduction of the cable or cables and compressed air (typically from an air compressor via air pipe 201) into the fitting 2, respectively.

FIG. 6 additionally illustrates a microduct air adaptor fitting 150 used in embodiments of the invention where the elongate flexible member laid within the pipe is a microduct. In such embodiments one or more cables or fibres are subsequently pushed along the inserted microduct. The fitting 150 comprises a body portion 152 and openings 154, 156, 158. The opening 158 is adapted for connection to a compressed air supply flowing in the in the direction shown by arrow 202. In this instance, the air supply is provided by air compressor 200. The fitting comprise a microduct opening 154 adapted to receive the end of the microduct laid within the pipe. The opening 154 is provided with sealing means 162 adapted to seal round the exterior of the microduct. The fitting 150 comprises a further opening 156 adapted to receive a cable to be pushed down the microduct. A seal 160 is provided within the opening 156 adapted to fit around the inserted cable. The seals 160, 162 are adapted to ensure that compressed air introduced through opening 158 is directed along the interior of the microduct. This flow of compressed air helps carry the cable along eth microdot and reduces the friction between the cable and the interior walls of the microduct. This greatly aids the introduction of the cable into the microduct.

FIG. 7 shows how a kit of parts in accordance with the present invention which includes one or more connector fittings 2 as shown in any FIGS. 1 to 6 may be used to introduce one or more elongate flexible members into a fluid pipe 22.

The kit of parts shown includes a flexible member 330 (which may be a cable or microduct, for example), a connector fitting 2 which is connected to a portion of the fluid pipe 22 and a means to enable the flexible member 330 to be blown along a fluid pipe 22 in the form of a blowing sponge 300. In use, the blowing sponge 300 is releasably connected to the end of the flexible member 330 and subsequently introduced through a bore in the protruding portion 10 of the connector fitting 2 into the interior of the fluid pipe 22. Subsequently, an air compression unit 100 as shown in FIGS. 5 and 6 may be connected to the connector fitting 2 to provide a supply of compressed air along the pipe in the direction shown by arrow 302. This flow of compressed air acts on the blowing sponge 300 to move the sponge along the fluid pipe 22 in the direction of the air flow along the pipe 22. In this way, the kit of parts provides a means to introduce and subsequently move a flexible member 330 along a length of the fluid pipe 22.

FIG. 8 illustrates how a kit of parts in accordance with the present invention which includes one or more connector fittings 2 as shown in any FIGS. 1 to 6 may be used to remove an elongate flexible member 430 (which may be a cable or microduct, for example) from within a fluid pipe 22 as the flexible members 430 is blown along the pipe 22, which may be by the means shown in FIG. 7.

The kit of parts shown includes an extraction scoop 400 and a flexible member 430 which has been blown along the pipe 22 in the direction of arrow 402. In use, the extraction scoop 400 is placed within the interior of the pipe 22 through an opening 23 within the pipe 22. The opening 23 may be formed by any means which may be core-drilling or the like. The extraction scoop 400 is configured such that as the flexible member 430 is blown along the pipe 22, it acts to direct the flexible member 430 up and out of the pipe 22 through the opening 23. In this way, the kit of parts provides a means to remove a flexible member 430 from within the fluid pipe 22. Subsequent to this removal, a further connector fitting (not shown) may be used to provide a water tight seal about opening 23 in the fluid pipe 22.

In this way, a kit of parts combining features of the kits shown in FIGS. 7 and 8 provide a means to lay one or more elongate flexible members 330, 430 along a length of pre-existing fluid pipe 22.

FIG. 9 illustrates the implementation of two connector fittings 2a, 2b in accordance with the invention within a pipe system 500. In the illustrated embodiment, the pipe system 500 is operable in use to supply water to a building 502. Pipe system 500 comprises a fluid pipe 522 which is split into a first section 522a corresponding to the mains water supply, a second section 522b corresponding to the section of pipe through which the connector fittings 2a, 2b are used to lay one or more fibres or cables therealong, and a third section 522c corresponding to the section of pipe supplying water the building 502. The pipe system 500 also includes a water meter 504 within the first section of the pipe 522a.

In use, a first connector fitting 2a is fitted at a first point along the water pipe 522. The connector fitting 2a may be of any form as described above and may be installed onto the pipe 522 in any of the described ways. The first connector fitting 2a is used to introduce cable 30 into the interior of the pipe 522. The cable 30 may be connected at a distal end to a street fibre run or cabinet for providing cable connections to a plurality of buildings within a given area.

The cable 30 is introduced into the pipe at connector fitting 2a and along pipe section 522b. At a second point along the water pipe 522, a second connector fitting 2b is connected. Again, the connector fitting 2b may be of any form as described above and may be installed onto the pipe 522 in any of the described ways. The second connector fitting 2b is used to remove cable 30 from within the interior of the pipe 522. In use, this cable 30 may then be subsequently connected to a fibre termination unit 506 at the building 502 from which cable connections within the building 502 itself may stem.

In this way, the connector fittings 2a, 2b illustrated in FIG. 9 may be used to lay one or more cables along a pre-existing fluid pipe 522 for providing cable connections to the building 502 without the need to lay one or more further conduits specifically for the cable 522 itself.

FIG. 10 illustrates a further implementation of a pair of connector fittings 2a, 2b in accordance with the invention showing how the connector fittings 2a, 2b may be used to provide cable connections to a plurality of different rooms or areas within a building, such as an apartment block or the like. In the illustrated embodiment, the apartment block or building (not labelled) includes a pipe system 600 which is operable in use to supply water to a plurality of floors, rooms or given areas within the building. Pipe system 600 comprises a mains fluid pipe 622a. The mains supply pipe 622a feeds a water storage tank 602 which in turn supplies a rising water main 622d for providing a water supply to a number of different floors within the building. To enable water to rise along rising water main 622d, the pipe system 600 additionally comprises a water pump 606.

FIG. 10 illustrates a single level of the apartment block/building which pipe system 600 supplies. To supply water to this level, the rising water main 622d includes a T-joint 608 which splits the water supply. The T-joint 608 in turn supplies a water distribution manifold 610 which further splits the water supply into a plurality of separate pipe lines for supplying a corresponding number of rooms/areas on that particular floor of the apartment block/building. For simplicity, only a single pipe line 622b is described. It should, however, be appreciated that equivalent connector fittings to fittings 2a, 2b may be applied to any number of the separate pipe lines as desired.

In addition, the pipe system 600 includes first and second valves 612, 614. These valves are operable in use to control the flow of fluid along the pipe line 622b and may be used during installation of pipe connector fittings 2a, 2b as will be described hereinbelow. In particular, the valves 612, 614 may be used to cut the flow of water along the pipe line 622b to prevent fluid being expelled from within the pipe line 622b during installation of the connector fitting/s 2a, 2b.

Alongside the pipe system 600, a cable system 630 is provided for supplying one or more cable connections to the apartment block/building. The cable system 630 comprises a mains cable supply 630a which supplies a network splitter unit 616 for splitting the mains cable supply 630a into a plurality of separate lines for supplying a plurality of areas within the apartment block or adjacent/proximal buildings. For simplicity, only a single cable line 630b is described.

As with rising water main 622d, cable line 630b is operable in use to provide cable connections to a number of different floors or levels within the apartment block/building. In the illustrated embodiment, cable line 630b is split at breakout box 618 into a plurality of secondary cable lines for supplying any number of rooms/areas within a single floor or level of the building. Again, for simplicity, only a single secondary cable line 630c is described.

Secondary cable line 630c is itself introduced into the pipe line 622b in the same way as described above with reference to cable 30 and pipe line 22b in FIG. 9. Specifically, the cable line 630c is introduced into pipe line 622b using the first pipe connector fitting 2a, and removed from within the pipe line 622b using the second connector fitting 2b at a position downstream of the first connector fitting 2a.

Generally, in systems of the type shown in FIG. 10, the water distribution manifold 610 and breakout box 616 are located within a services cabinet in which any number of different pipe or cable lines may be located. As such, the various pipe and cable lines within the cabinet are generally located in a confined space and it is in this space in which it is necessary to connect a connector fitting operable to introduce one or more cables into a pipe line. The configuration of the connector fittings 2a, 2b enables them to be connected to a fluid pipe within a cabinet where other, known connector fittings would either be too large, or would be difficult to install within the cabinet given the necessity to cut away section of a corresponding water pipe in order to connect them. The connector fitting of the present invention allows for the sections of the fitting to be placed around the pipe and connected thereto with the only requirement to provide a core-drilled hole in the pipe rather than cut away an entire section of the pipe during installation.

Whilst the embodiments shown in FIGS. 4, 9 and 10 illustrate how a single elongate flexible member in the form of a cable 30, or cable section 630c is introduced into a fluid pipe using one or more connector fittings of the invention, it should be understood that the single elongate flexible member may comprise a microduct or the like. In such embodiments, the micro-duct may be operable to house at least one cable. It should also be understood that in some embodiments of the invention the connector fitting/s may be used to lay more than one elongate flexible members, which may comprise one or more cables and/or microducts. Where one or more cables are introduced either directly into a fluid pipe, or indirectly by means of placing the cables within a microduct or the like, the cables, such as cable 30, or cable section 630c may comprise an optical cable. The or each cable or cable section may additionally be provided with an insulating sheath and may be a single core or multi-core cable as desired.

The above embodiments are described by way of example only. Many variations are possible without departing from the scope of the invention as defined in the appended claims.

1-38. (canceled)

39. A pipe connector fitting for introducing one or more elongate flexible members into a fluid pipe, the connector fitting comprising: a body formed from at least two connectable sections which, when connected, provides a hollow interior adapted to fit coaxially about the fluid pipe providing a watertight fit therewith; wherein at least one section of the body comprises a protruding portion having a bore therethrough, the bore providing access to the interior of the body from the exterior of the body enabling the introduction of the one or more elongate flexible members into the fluid pipe through said aperture and a corresponding opening within the pipe itself.

40. A pipe connector fitting as claimed in claim 39 wherein at least one of the sections forming the body of the connector fitting additionally comprises an outwardly extending flange wherein the or each outwardly extending flange provides a means to connect the corresponding section to an adjacent section of the body, in use.

41. A pipe connector fitting as claimed in claim 39 wherein the protruding portion comprises an outwardly extending tube.

42. A pipe connector fitting as claimed in claim 41 wherein the connector fitting additionally comprises an adaptor fitting operable in use to be located within the bore of the protruding portion, operable in use to accommodate elongate flexible members with different diameters.

43. A connector fitting as claimed in claim 42 wherein the adaptor fitting comprises a secondary bore therethrough, smaller than the bore of the protruding portion which is specifically dimensioned to accommodate elongate flexible members having a given diameter.

44. A pipe connector fitting as claimed in claim 41 wherein the protruding portion is positioned such that the bore is directed at an angle which is not perpendicular to the direction of flow of fluid along the pipe.

45. A pipe connector fitting as claimed in claim 41 wherein the protruding portion extends inwardly forming a spur which extends into the interior of the body of the connector fitting.

46. A pipe connector fitting as claimed in claim 45 wherein at least a portion of the inwardly extending spur is dimensioned to be received within the opening in the pipe, in use.

47. A pipe connector fitting as claimed in claim 39 adapted to enable a source of compressed air to be connected thereto, operable to supply compressed air to the interior of the connector fitting, in use.

48. A kit of parts for laying one or more elongate flexible members within a fluid pipe, the kit of parts comprising at least one connector fitting as claimed in claim 39 and one or more elongate flexible members.

49. A kit of parts as claimed in claim 48 comprising a source of compressed air operable in use to introduce compressed air into the interior of the at least one connector fitting to enable the one or more elongate flexible members to be blown along a connected fluid pipe.

50. A kit of parts as claimed in claim 49 wherein the source of compressed air is an air compressor connectable to the connector fitting via an air adaptor fitting;
or wherein the elongate flexible member is a microduct and the kit of parts additionally comprises a microduct air adaptor fitting operable to enable both cables and compressed air to be introduced to the interior of the microduct.

51. A kit of parts as claimed in claim 48 comprising an extraction scoop, operable in use to extract one or more elongate flexible members from within a fluid pipe.

52. A method of laying one or more elongate flexible members within a fluid pipe using a pipe connector fitting as claimed in claim 1, the method comprising the steps of:
(a) locating the body of the connector fitting coaxially about a portion of the fluid pipe by positioning two or more sections of the body around the pipe;
(b) securing the sections of the body in position by connecting each of the two or more sections to at least one further section of the body; and
(c) introducing one or more elongate flexible members intro the fluid pipe through a bore in a protruding portion of a section of the body and a corresponding opening in the pipe.

53. A method as claimed in claim 52 wherein locating the body of the connector fitting coaxially about a portion of the fluid pipe comprises initially locating a first section of the body in position by introducing an inner protruding spur into the opening within the fluid pipe.

54. A method as claimed in claim 52 wherein the opening in the pipe is provided by core drilling the pipe.

55. A method as claimed in claim 52 additionally comprising blowing the one or more elongate flexible members introduced into the fluid pipe along a length of the pipe.

56. A method as claimed in claim 55 wherein the one or more elongate flexible members are blown along the pipe using a source of compressed air.

57. A method as claimed in claim 56 comprising extracting the one or more members from within the pipe at a desired location through an additional opening within the pipe at said location by placing an extraction scoop into the pipe, through the additional opening which acts to guide the one or more elongate flexible members out from within the pipe through the opening.

58. A method as claimed in claim 52 wherein the elongate flexible member is a microduct and the method includes the step of pushing a cable along the microduct after insertion into and extraction from the pipe.
